(19) United States
(12) Patent Application Publication
(10) Pub. No.: US 2016/0159321 A1
(43) Pub. Date: Jun. 9, 2016

(54) ACCESS CONTROL SYSTEM FOR A MOTOR VEHICLE

(71) Applicant: JOHNSON CONTROLS AUTOMOTIVE ELECTRONICS SAS, Cergy Pontoise Cedex (FR)

(72) Inventor: Gregoire LAGABE, Paris (FR)

(21) Appl. No.: 14/901,093

(22) PCT Filed: Jun. 25, 2014
(86) PCT No.: PCT/EP2014/063389

§ 371 Date: Feb. 17, 2016

(30) Foreign Application Priority Data
Jun. 28, 2013 (FR) 13/01531

(51) Int. Cl. B60R 25/31

(52) U.S. Cl. CPC B60R 25/31

(57) ABSTRACT

An access control system for activating functionalities of a motor vehicle using a remote control includes: the remote control; an access control unit located in the motor vehicle, configured to communicate wife the remote control via radiofrequency signals; one or more components for locating a user via a location of the remote control by determining the position of the remote control in an environment, close to the motor vehicle or inside the motor vehicle, the environment being divided into a plurality of predetermined zones; and one or more components for associating the determined position of the remote control with a single zone of the plurality of predetermined zones. The remote control includes a detection unit, the detection unit being configured to detect different movements of the remote control for activation of at least one functionality of the motor vehicle.

### CROSS-REFERENCE TO RELATED APPLICATIONS

This application is a U.S. National Phase application under 35 U.S.C. §371 of International Application No. PCT/EP2014/063389, filed on Jun. 25, 2014, and claims benefit to French Patent Application No. FR 13/01531, filed on Jun. 28, 2013. The International Application was published in French on Dec. 31, 2014, as WO 2014/207041 A1 under PCT Article 21(2).

### FIELD

The present invention relates to an access control system for a motor vehicle, notably for activating functionalities of the motor vehicle using radiofrequency signals emitted and/or received by a remote control and by an access control unit located in the motor vehicle, the access control system allowing for a selective access control as a function of the position of the user.

### BACKGROUND

Remote controls—also called manual emitters—are generally known for different vehicle functions, the remote controls being incorporated notably in a vehicle key or a key fob. Such remote controls are used for so-called remote keyless access (or remote keyless entry) functions, which emit radiofrequency signals that make it possible to verify the authorization of the user to perform functionalities of the motor vehicle, notably to open and/or to close vehicle door locks, vehicle shutters and vehicle hoods, to trigger an alarm, called panic alarm, of an alarm installation of the vehicle, start up an engine driving the vehicle, open and close windows of the vehicle and sunroofs, and automatically open and close sliding doors of the vehicle. Furthermore, such remote controls used for keyless access system functions of a vehicle are called keyless go systems.

In particular, access control systems are known from the prior art in which a person confirms his or her identity as user having an access authorization by the possession of a key or a key card. These access control systems are characterized by the name “keyless-entry/keyless-go”, it being understood that no traditional mechanical action key is used and that the authorization can extend, in addition to access to the vehicle, also to its use for the driving thereof.

In the case of these systems, the presence of a key card is checked after a sensor incorporated in the vehicle has detected a control action. The door handles are for example equipped with switches, the actuation of which is detected by the system, after which a radiofrequency signal is emitted by the vehicle, by which radiofrequency signal the key card is activated so as to produce a response and its presence can consequently be determined.

In the presence of an authorization, a desire to access is acceded to by the fact that the control system controls electromechanical actuators for the unlocking of door locks, and does so, as a function of a preselection, for all of the doors present, or, optionally, only for the door with the handle where the actuation has been detected.

As it happens, it is disadvantageous that it is normally necessary for the user to press on different keys of the remote control or make different gestures with the remote control assembly: the use of the access control system is not very intuitive.

### SUMMARY

In an embodiment, the invention provides an access control system for activating functionalities of a motor vehicle using a remote control. The access control system includes: the remote control; an access control unit located in the motor vehicle, configured to communicate with the remote control via radiofrequency signals; one or more components for locating a user via a location of the remote control by determining the position of the remote control in an environment close to the motor vehicle or inside the motor vehicle, the environment being divided into a plurality of predetermined zones; and one or more components for associating the determined position of the remote control with a single zone of the plurality of predetermined zones. The remote control includes a detection unit, the detection unit being configured to detect different movements of the remote control for activation of at least one functionality of the motor vehicle. The detection unit is configured to generate different detection signals as a function of the single zone associated with the determined position of the remote control and/or as a function of the determined position of the remote control and/or as a function of the different movements of the remote control. The access control system further includes: a decision unit, configured to select a functionality of the motor vehicle as a function of a detected movement and of the zone and/or the determined position of the remote control.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a motor vehicle and a pattern of zones associated with the motor vehicle as well as a remote control for an access control system according to the present invention;

FIG. 2 schematically illustrates an access control unit located in the motor vehicle;

FIG. 3 schematically illustrates a representation of an example of actuating a functionality of the motor vehicle using a movement of the remote control assembly; and

FIGS. 4 and 5 schematically illustrate another representation of the motor vehicle with the pattern of zones as in FIG. 1, and a remote control for an access control system according to the present invention in the situation in which the same gesture is used to trigger a different functionality of the motor vehicle as a function of the position of the user.

### DETAILED DESCRIPTION

Embodiments of the present invention provide an improved remote control system for vehicle functions.

In an embodiment, the invention provides an access control system for a motor vehicle, notably for activating functionalities of the motor vehicle using radiofrequency signals emitted and/or received by a remote control and by an access control unit located in the motor vehicle, said access control system comprising, apart from the remote control and the access control unit:

one or more components for locating a user via a location of the remote control by determining the position of the remote control, the location of the remote control being provided in the environment close to the motor vehicle or inside the motor vehicle, the environment close to the motor vehicle and inside the motor vehicle being divided into a plurality of predetermined zones,

one or more components making it possible to associate the determined position of the remote control with a single zone of the plurality of predetermined zones, the remote control comprising a detection unit, the detection unit being configured to detect different movements of the remote control assembly for the activation of at least one functionality of the motor vehicle,

the detection unit generating different detection signals

as a function of the single zone associated with the determined position of the remote control and/or

as a function of the determined position of the remote control and/or

as a function of the different movements of the remote control assembly and a decision unit selects the functionality of the motor vehicle as a function, on the one hand, of the different movements detected and, on the other hand, of the zone and/or of the determined position of the remote control.

The invention comprises one or more components for locating a user relative to the vehicle, such that the position of the user relative to the vehicle (for example according to the direction and the distance) can be determined. The one or more components may include a network of antennas for locating a radio signal emanating from a key card that the user is in possession of or be formed by image sensors which allow for an identification of the user and consequently, at the same time, a detection of authorization, or similar.

The invention further comprises one or more components whereby the outside close region is divided into a pattern of mutually adjacent zones. The latter may be, for example, a memory module in which are stored ranges of values for the coordinates. A location information item can consequently be associated with one of the ranges of values, that is to say one of the zones.

The invention thus makes it possible to determine whether the remote control (and thus the user of the motor vehicle) is located in the close environment of the motor vehicle. Correspondingly, a control unit can control actuators in a targeted manner in order to assist by anticipation a presumed action of the user corresponding to the movement.

According to the present invention, the remote control includes a detection unit, the detection unit being configured to detect different movements of the remote control assembly for the activation of at least one functionality of the motor vehicle. The detection unit generates different detection signals as a function of the single zone associated with the determined position of the remote control and/or as a function of the determined position of the remote control. It is preferable, but only if the remote control is located in the close environment of the motor vehicle, for the detection unit to detect the movements of the remote control assembly.

A person skilled in the art will understand that access in the meaning of the present invention is not limited to the region of the driver or of the passengers. It can also concern separate regions such as the trunk, the engine compartment or similar.

According to the present invention, it is advantageously possible for not only the position of the user to be determined but also the movement of the user. The movement of the user can be determined by repeatedly locating the latter at time intervals. Correspondingly, a control unit can control actuators in a targeted manner in order to assist in an anticipated manner in a presumed action of the user corresponding to the movement.

According to another preferred embodiment according to the present invention, it is preferable for the detection unit to be:

a unit for detecting the linear acceleration of the remote control and/or

a unit for detecting the rotary acceleration of the remote control and/or

a unit for detecting the position of the remote control relative to a gravitational field or relative to a magnetic field.

Thus, it is advantageously possible, according to the present invention, to use linear acceleration sensors and/or rotary acceleration sensors and/or magnetic field sensors.

According to another preferred embodiment according to the present invention, it is preferable for the remote control to comprise an analysis unit for detecting the movements and for differentiating between the movements.

Through such an embodiment of an access control system, it is advantageously possible according to the present invention to produce the differentiation between the different movements (to control the remote control or to control the functionalities of the motor vehicle) within the remote control. In this case, the radiofrequency signals are specific signals for each movement (that is to say for each functionality to be controlled of the motor vehicle). According to another embodiment, the remote control does not comprise an analysis unit for detecting the movements and for differentiating between the movements, but such an analysis unit is implemented inside the access control unit which is normally located in the motor vehicle. In the case where the remote control does not comprise an analysis unit, the radiofrequency signals emitted by the remote control are radiofrequency signals which correspond respectively to the movements but which are not specific for the different movements, and—consequently—which are not specific to each functionality to be controlled of the motor vehicle.

According to another preferred embodiment according to the present invention, it is preferable for radiofrequency signals to be exchanged between the remote control and the access control unit in order to check the authorization of the remote control to activate functionalities of the motor vehicle.

Through such an embodiment of an access control system, it is advantageously possible according to the present invention to implement the access control to the motor vehicle simply and effectively.

Other features and advantages of the invention will become apparent on reading the following description of a non-limiting particular embodiment of the present invention.

The invention will be better understood from the following description, which relates to preferred embodiments, given as non-limiting examples and explained with references to the attached schematic drawings.

The parts which correspond with one another in all the figures are provided with the same reference numbers.

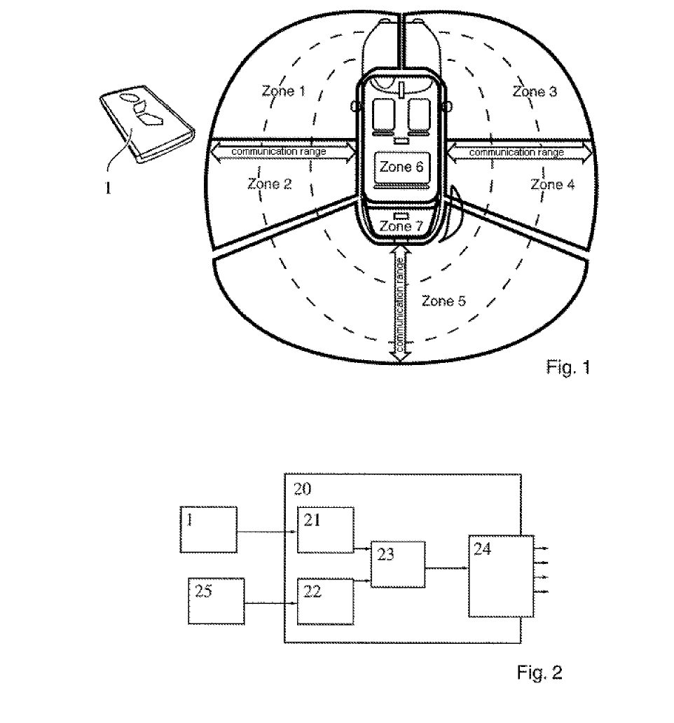

FIG. 1 schematically illustrates a motor vehicle 2 and a pattern of zones associated with the motor vehicle 2 as well as a remote control 1 for an access control system according to the present invention. In the pattern of zones associated with the motor vehicle, the zone limits are indicated by unbroken lines.

The access control system for the motor vehicle 2 according to the present invention is notably provided to activate functionalities of the motor vehicle 2. This is normally done using radiofrequency signals which are emitted and/or received by a remote control 1 and by an access control unit located in the motor vehicle 2.

The zone limits are indicated, in FIG. 1, by unbroken lines. The zones are indicated in FIG. 1 by the designations “zone 1”, corresponding to a first zone, “zone 2”, corresponding to a second zone, “zone 3”, corresponding to a third zone, “zone 4”, corresponding to a fourth zone, “zone 5”, corresponding to a fifth zone, “zone 6”, corresponding to a sixth zone, and “zone 7”, corresponding to a seventh zone.

The access control system comprises, apart from the remote control 1 and the access control unit, one or more components for locating a user via a location of the remote control 1 by the determination of the position of the remote control 1. The location of the remote control 1 is provided in the close environment of the motor vehicle 2 or inside the motor vehicle 2. The first zone in FIG. 1 corresponds to a zone of the door of the driver of the motor vehicle 2. The second zone in FIG. 1 corresponds to a zone of the left rear door of the motor vehicle 2. The third zone in FIG. 1 corresponds to a zone of the door of the passenger of the motor vehicle 2. The fourth zone in FIG. 1 corresponds to a zone of the right rear door of the motor vehicle 2. The fifth zone in FIG. 1 corresponds to a zone behind the motor vehicle 2. The sixth zone in FIG. 1 corresponds to the interior of the motor vehicle 2. The seventh zone in FIG. 1 corresponds to a zone of the or above the trunk of the motor vehicle 2. An eighth zone corresponds to a zone of the tank filler cap of the motor vehicle 2.

The representation of the zones in FIG. 1 comprises—apart from the unbroken lines indicating the zones or rather the communication radius of the zones—two broken lines in the first, second, third, fourth, fifth, sixth and seventh zones and passing almost completely around the motor vehicle: a first inner line, that is to say closer to the motor vehicle 2, and a second outer line, that is to say further away from the motor vehicle 2. The first broken line serves as a limit for opening the motor vehicle when a user—that is to say the remote control 1—approaches the motor vehicle 2. The second broken line serves as a limit for closing the motor vehicle 2 when a user—that is to say the remote control 1—moves away from the motor vehicle 2.

According to the present invention, it is possible to locate a user via a location of the remote control 1 by the determination of the position of the remote control 1 around the motor vehicle (that is to say in a close environment of the motor vehicle 2, for example a few meters away from the motor vehicle 2) or inside the motor vehicle 2.

Using the relatively accurate location of the remote control 1 (or of the user), it is advantageously possible according to the present invention to associate a single zone which is the current zone of the remote control (out of the plurality of the zones mentioned above) with each given instant. The (relatively accurate) determined position of the remote control 1 can then be associated with a single zone (that is to say the current zone) out of the plurality of local zones (that is to say the first, second, third, fourth, fifth, sixth, seventh and eighth zones). The accuracy of determination of the position of the remote control 1, notably around the motor vehicle 2, is of the order of a few decimeters or of the order of a few centimeters, notably from one centimeter to 100 centimeters, preferably from 2 centimeters to 80 centimeters, preferably from 5 centimeters to 50 centimeters.

According to the present invention, the remote control comprises a detection unit, the detection unit being configured to detect to detect different movements of the user on the remote control assembly, the movements being provided for the activation of different functionalities of the motor vehicle. According to the present invention, the detection unit generates different detection signals as a function of the single zone associated with the determined position of the remote control and/or as a function of the determined position of the remote control.

Thus, according to the present invention, the detection unit inputs the movements of the remote control and makes it possible—with the precise location of the user—to associate a single movement with different functionalities according to the different positions of the user.

According to the present invention, it is preferable for a sequential control to form part of the access control unit, the sequential control being configured to execute, several times repeatedly, the locating of the remote control 1 and the association of the remote control 1 with a single zone of the plurality of local zones. This repeated execution of the sequential control generates a sequence of information items regarding the position of the remote control 1 also making it possible to detect a direction of movement of the remote control 1.

The access control unit comprises a plurality of actuators in the motor vehicle or the access control unit is associated with a plurality of actuators in the motor vehicle. The actuators are, for example, associated with the locks of the doors of the motor vehicle.

A part of—notably—the fifth zone can be a prohibited zone. Through the precise location of the user, prohibited zones (or parts of zones) can be defined in such a way that functionalities of the motor vehicle are not triggered when the remote control is detected as being positioned in such a prohibited zone (or part of zone).

In FIG. 2, an access control unit 20 located in the motor vehicle is schematically illustrated. The remote control 1 comprises a movement detection unit. The access control unit 20 preferably comprises one or more components for locating the remote control 25, notably antennas that can pick up the radiofrequency signals from the remote control 1. Moreover, the access control unit 20 comprises or is associated with a radiofrequency unit 21, a location unit 22, an association unit 23 and a plurality of control units 24. When the remote control 1 is subjected to a movement (on the part of the user; notably after the user has pressed on an actuation element of the remote control 1), the remote control—using the movement detection unit—detects the movement, and sends a radiofrequency message or a radiofrequency signal (to the motor vehicle and therefore to the access control unit) corresponding to the movement detected by the movement detection unit. The radiofrequency signal or the radiofrequency message is received by the radiofrequency unit 21 of the access control unit 20 and a movement information item is transmitted to the association unit 23—notably by wired transmission. Moreover, the location unit 22 detects—by an exchange of radiofrequency signals with the remote control 1—the remote control 1, and the location unit 22 determines the location or the position of the remote control 1. The position or the location of the remote control 1 is transmitted to the association unit 23—notably by wired transmission. On the basis of the movement information item and of the position or the location of the remote control 1, the association unit 23 can control the control units 24 to actuate actuators in the motor vehicle. The transmission between the association unit 23 and the control units 24 is notably provided over the vehicle network.

The remote control 1 detects a movement (knowing that the control detection unit is advantageously activated by pressing (prolonged or not) on a button of the remote control) and sends a radiofrequency message corresponding to the detected movement. In parallel, the access control unit (knowing that the access control unit can include one or more computation units—for example, there may be a separate RF communication unit) and the associated location unit locate the remote control and position it in one of the predetermined zones of the interior or exterior environment of the vehicle). Then, it is a computation unit of the vehicle (called decision unit which will advantageously also be the access control unit or which forms part of the access control unit) which performs the association of the movement detected and sent by the remote control and of the position of this same remote control to decide on the functionality to be controlled (for example, and in a nonexhaustive manner: the control of an opening (sunroof, sliding side door, trunk, convertible roof, window), tilting up of an outside rearview mirror, switching on of external or interior lights, the horn or other sound emitter, etc.). The control to be performed will be either produced by this same computation unit or else sent over the vehicle network to the relevant control member.

According to the embodiment of FIG. 3, the remote control 1 generates a signal as a function of the gesture performed by the remote control (that is to say as a function of the movement or of the different movements of the remote control 1 assembly) but which is independent of the position of the remote control 1; the association with the position of the remote control 1 can in effect be produced by a control unit incorporated in the vehicle.

FIG. 3 schematically illustrates a representation of an example of actuating a functionality of the motor vehicle using a movement of the remote control assembly: The functionality—in this case for example the opening of a roof—can be provided such that the functionality is triggered only when the remote control is located in a certain predetermined zone, for example the fifth zone, and that a specific movement—for example a circular movement to the right (about an axis directing toward the motor vehicle)—is produced with the remote control assembly.

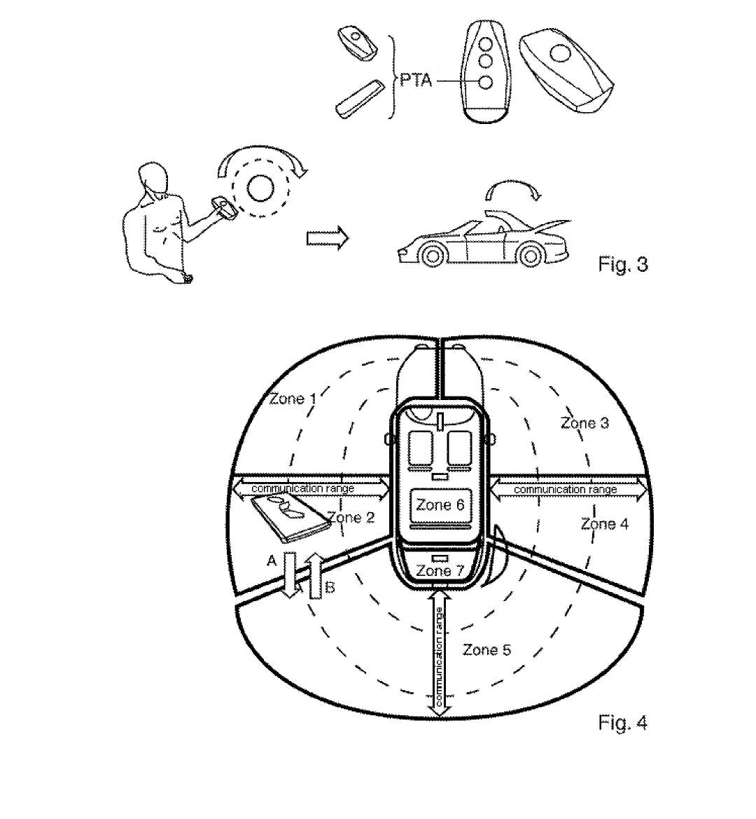

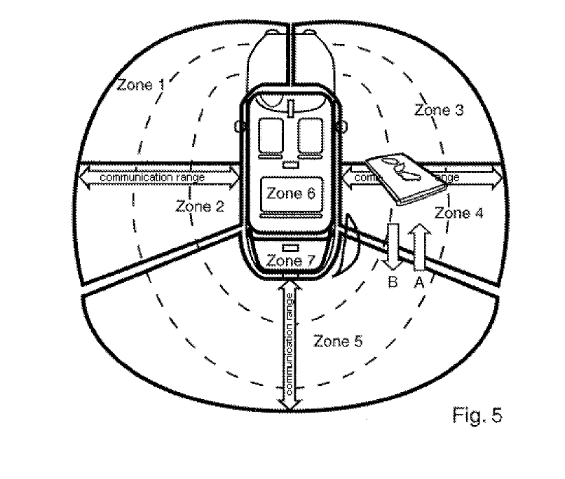

FIGS. 4 and 5 schematically illustrate another representation of the motor vehicle with the pattern of zones as in FIG. 1, as well as a remote control for an access control system 20 according to the present invention in the situation in which the same gesture (for example a horizontal motion from the user) is used to trigger a different functionality of the motor vehicle as a of the position of the user: when the user is located on the left side of the motor vehicle (represented in FIG. 4) the same gesture (horizontal motion from left to right (arrow A) or from right to left (arrow B)) serves to open or to close a door (for example a sliding door) on the left side of the motor vehicle, and when the user is located on the right side of the motor vehicle (represented in FIG. 5), the same gesture (horizontal motion from right to left (arrow B) or from left to right (arrow A)) serves to open or to close a door (for example a sliding door) of the right side of the motor vehicle.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An access control system for activating functionalities of a motor vehicle using remote control, the access control system comprising:
the remote control;
an access control unit located in the motor vehicle, configured to communicate with the remote control via radiofrequency signals;
one or more components for locating a user via a location of the remote control by determining the position of the remote control in an environment close to the motor vehicle or inside the motor vehicle, the environment being divided into a plurality of predetermined zones; and,
one or more components for associating the determined position of the remote control with a single zone of the plurality of predetermined zones;
wherein the remote control comprises a detection unit, the detection unit being configured to detect different movements of the remote control for activation of at least one functionality of the motor vehicle;
wherein the detection unit is configured to generate different detection signals as a function of the single zone associated with the determined position of the remote control and/or as a function of the determined position of the remote control and/or as a function of the different movements of the remote control; and
wherein the access control system further comprises:
a decision unit, configured to select a functionality of the motor vehicle as a function of a detected movement of the zone and/or the determined position of the remote control.

2. The access control system according to claim 1, wherein the detection unit is:
a unit for detecting the linear acceleration of the remote control; and/or
a unit for detecting the rotary acceleration of the remote control; and/or
a unit for detecting the position of the remote control relative to a gravitational field or relative to a magnetic field.

3. The access control system according to claim 1, wherein the remote control comprises an analysis unit for detecting movements and for differentiating between movements.

4. The access control system according to claim 1, wherein the remote control and the access control unit are configured to exchange; radiofrequency signals for verifying the authorization of the remote control to activate functionalities of the motor vehicle.

5. The access control system according to claim 1, wherein the decision unit is located in the remote control or in the motor vehicle.
